(19) United States
(12) Patent Application Publication
(10) Pub. No.: US 2025/0008064 A1
(43) Pub. Date: Jan. 2, 2025

(54) CORRECTION DEVICE, NON-TRANSITORY COMPUTER-READABLE MEDIUM STORING CORRECTION PROGRAM, AND CORRECTION METHOD

(71) Applicant: LAPIS Technology Co., Ltd., Yokohama-shi (JP)

(72) Inventor: Tomoyuki ICHIKAWA, Yokohama-shi (JP)

(73) Assignee: LAPIS Technology Co., Ltd., Yokohama-shi (JP)

(21) Appl. No.: 18/753,535

(22) Filed: Jun. 25, 2024

(30) Foreign Application Priority Data
Jun. 30, 2023 (JP) 2023-108603

(51) Int. Cl. H04N 9/64; H04N 9/78

(52) U.S. Cl. CPC H04N 9/646; H04N 9/78

(57) ABSTRACT

A correction device including: a memory; and a processor coupled to the memory, the processor configured to: receive a modulated video signal; separate the modulated video signal into a color difference signal and a luminance signal; and in cases in which a luminance component change value in a given frequency band in a demodulated luminance signal, demodulated from the luminance signal, is a given threshold or greater, perform correction such that color difference components present in a demodulated color difference signal demodulated from the color difference signal and corresponding to the luminance components are emphasized, compared to cases in which the change value is less than the given threshold.

### CROSS-REFERENCE TO RELATED APPLICATION

This application claims priority under 35 USC 119 from Japanese Patent Application No. 2023-108603, filed on Jun. 30, 2023, the disclosure of which is incorporated by reference herein.

### BACKGROUND

### Technical Field

The present disclosure relates to a correction device, a non-transitory computer-readable medium storing a correction program, and a correction method.

### Related Art

When video signals are transmitted using analogue modulation, sometimes boundaries between one color and another color become blurred. In particular, in a YUV422 data format or the like, that shares some information from two adjacent pixels as a single set, color blur increases the narrower a frequency band range of color difference becomes with respect to luminance. In digital videos, the boundaries between one color and another color are clear, and there is a large change in color thereat. This means that sometimes color blur stands out when a digital video signal is transmitted using analogue modulation and analogue demodulation.

Japanese Patent Application Laid-Open (JP-A) No. 2010-199993, discloses a video signal processing device. This video signal processing device includes a smoothing block that reduces gradation differences of a plane region of an input digital video signal according to a parameter. Such a video signal processing device also includes a frequency state determination block that is able to determine a frequency state of an input digital video signal, and that obtains a determination result as a first case for cases in which low side frequency components lower than a pre-set frequency are less than frequency components on the high side thereof. Note that the frequency state determination block obtains a determination result as a second case for cases in which the low side frequency components lower than the pre-set frequency are less than the high side frequency components. The video signal processing device also includes a correction parameter output block that outputs a correction parameter to enhance smoothing processing of the smoothing block when the determination result is the second case, more than when the determination result is the first case.

There is a method to improve color blur by performing correction to emphasize color difference components of a given frequency band in a demodulated color difference signal that has been demodulated from a color difference signal. However, unnatural color blur still stands out, when correction is similarly performed to emphasize color difference components for cases in which a luminance component change value is relatively small and color blur would not usually stand out so much anyway.

### SUMMARY

A first aspect of the present disclosure is a correction device including: a memory; and a processor coupled to the memory, the processor configured to: receive a modulated video signal; separate the modulated video signal into a color difference signal and a luminance signal; and in cases in which a luminance component change value in a given frequency band in a demodulated luminance signal, demodulated from the luminance signal, is a given threshold or greater, perform correction such that color difference components present in a demodulated color difference signal demodulated from the color difference signal and corresponding to the luminance components are emphasized, compared to cases in which the change value is less than the given threshold.

### BRIEF DESCRIPTION OF THE DRAWINGS

Exemplary embodiments will be described in detail based on the following figures, wherein:

FIG. 1 is a block diagram illustrating a hardware configuration of a correction device according to an exemplary embodiment;

FIG. 2 is a block diagram illustrating a functional configuration of a correction device according to the present exemplary embodiment;

FIG. 3 is a schematic diagram illustrating color difference components for a case in which a luminance component change value is a given threshold or greater;

FIG. 4 is a schematic diagram illustrating color difference components for a case in which a luminance component change value is less than the given threshold; and

FIG. 5 is a flowchart illustrating a flow of correction processing in a correction device according to the present exemplary embodiment.

### DETAILED DESCRIPTION

According to the present disclosure, the correction device, the non-transitory computer-readable medium storing a correction program, and the correction method of the present disclosure may improve the color blur, compared to cases in which correction is performed to emphasize color difference components irrespective of the luminance component change value.

Description follows regarding an example of an exemplary embodiment of the present disclosure, with reference to the drawings. Note that the same reference numerals will be appended in the drawings to the same or equivalent configuration elements and parts. Moreover, dimensions and proportions in the drawings are exaggerated for ease of explanation, and sometimes differ from actual proportions.

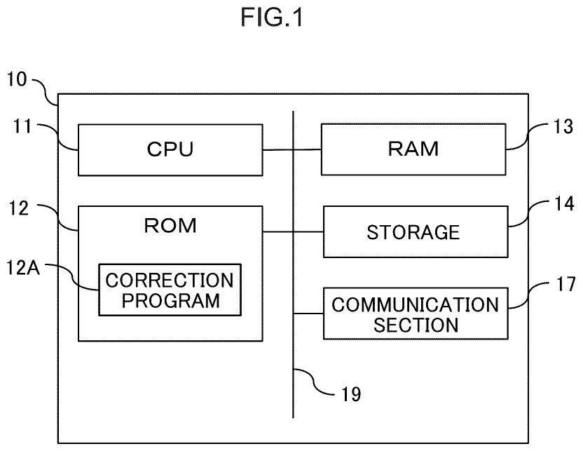

FIG. 1 illustrates a schematic configuration of a correction device 10 according to the present exemplary embodiment. As illustrated in FIG. 1, the correction device 10 according to the present exemplary embodiment includes a central processing unit (CPU) 11, read only memory (ROM) 12, random access memory (RAM) 13, storage 14, and a communication section 17. Each configuration is connected together through a bus 19 so as to be capable of communicating with each other. The CPU 11 is an example of a computer according to the present exemplary embodiment.

The CPU 11 is a central processing unit that executes various programs and controls each section. Namely, the CPU 11 reads a program from the ROM 12 or the storage 14, and executes the program using the RAM 13 as a workspace. The CPU 11 controls each of the above configuration and performs various computational processing according to programs stored on the ROM 12 or the storage 14. In the present exemplary embodiment, a correction program 12A is stored in the ROM 12. Note that the correction program 12A may be stored in the storage 14.

The ROM 12 is stored with various programs and various data. The RAM 13 serves as a workspace to temporarily store programs and/or data. The storage 14 is configured by a storage device such as a hard disk drive (HDD), solid state drive (SSD), or the like, and stores various programs including an operating system and various data.

The communication section 17 is an interface for communicating with other devices. and employs, for example, a standard such as Ethernet (registered trademark), FDDI, or Wi-Fi (registered trademark).

Next, description follows regarding a functional configuration of the correction device 10 according to the present exemplary embodiment.

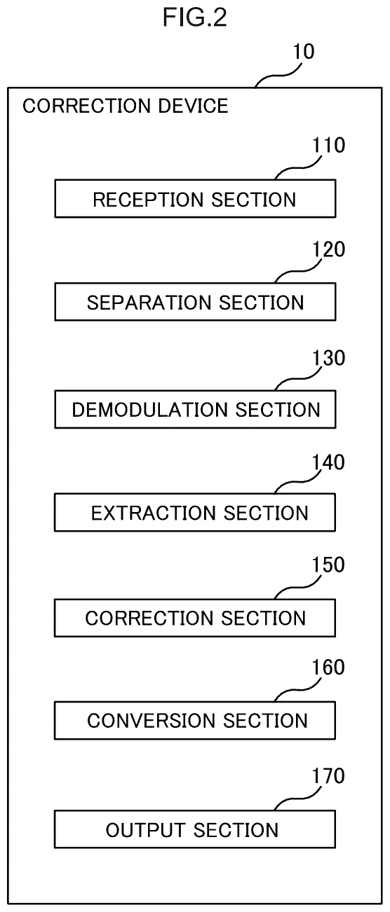

FIG. 2 is a block diagram illustrating an example of a functional configuration of the correction device 10.

As illustrated in FIG. 2, the correction device 10 includes, as functional configuration, a reception section 110, a separation section 120, a demodulation section 130, an extraction section 140, a correction section 150, a conversion section 160, and an output section 170. Each functional configuration is implemented by the CPU 11 reading and executing the correction program 12A stored on the ROM 12.

The reception section 110 receives a modulated video signal. The reception section 110 outputs the received video signal to the separation section 120.

The separation section 120 separates the video signal into a luminance signal and a color difference signal. The separation section 120 outputs the luminance signal and the color difference signal to the demodulation section 130.

The demodulation section 130 demodulates the luminance signal into a demodulated luminance signal. The demodulation section 130 outputs the demodulated luminance signal to the extraction section 140 and the conversion section 160. The demodulation section 130 demodulates the color difference signal into a demodulated color difference signal. The demodulation section 130 outputs the demodulated color difference signal to the extraction section 140 and the correction section 150. Note that, in the present exemplary embodiment, a single demodulation section 130 demodulates the luminance signal and the color difference signal. However, there is no limitation to such an example. The luminance signal and the color difference signal may be demodulated by separate demodulation sections.

The extraction section 140 extracts luminance components of a given frequency band from out of the demodulated luminance signal. For example, the extraction section 140 inputs the demodulated luminance signal to a band-pass filter and extracts luminance components therefrom. In the present exemplary embodiment, the given frequency band is predetermined by the administrator or the like of the correction device 10. However, there is no limitation to such an example. For example, the given frequency band may be determined based on frequencies of the demodulated luminance signal.

Moreover, the extraction section 140 extracts color difference components corresponding to the luminance components, from out of the demodulated color difference signal. The extraction section 140 outputs the luminance components and the color difference components to the correction section 150.

In cases in which a luminance component change value is a given threshold or greater, the correction section 150 corrects so as to emphasize the color difference components, compared to cases in which the change value is less than the given threshold. The correction section 150 then adds the corrected color difference components to the demodulated color difference signal. The correction section 150 then outputs, to the conversion section 160, the demodulated color difference signal with the added corrected color difference components.

In the present exemplary embodiment, the given threshold is predetermined by an administrator or the like of the correction device 10. However, there is no limitation to such an example. For example, the given threshold may be determined based on at least one out of a maximum value or a minimum value of the luminance components. For example, a value such as half the maximum value of the luminance components may be employed as the given threshold.

In the present exemplary embodiment, the correction section 150 multiplies the color difference components by a given positive number in cases in which the luminance component change value is the given threshold or greater. However, there is no limitation to such an example. In cases in which the luminance component change value is the given threshold or greater, the correction section 150 may add a given positive number to the color difference components, or may take the color difference components and divide by, or subtract, a given negative number. In such cases, the given positive number or the given negative number is predetermined by an administrator or the like of the correction device 10. However, there is no limitation to such an example. For example, the given positive number and the given negative number may be determined based on at least one out of a maximum value or a minimum value of the luminance components.

Moreover, the correction section 150 aborts correction of the color difference components, in cases in which the luminance component change value is less than the given threshold. The correction section 150 then outputs a demodulated color difference signal containing uncorrected color difference components to the conversion section 160. However, there is no limitation to such an example. In cases in which the luminance component change value is less than the given threshold, the correction section 150 may take the color difference components and subtract, or divide by, a given positive number, or may take the color difference components and add, or multiply by, a given negative number.

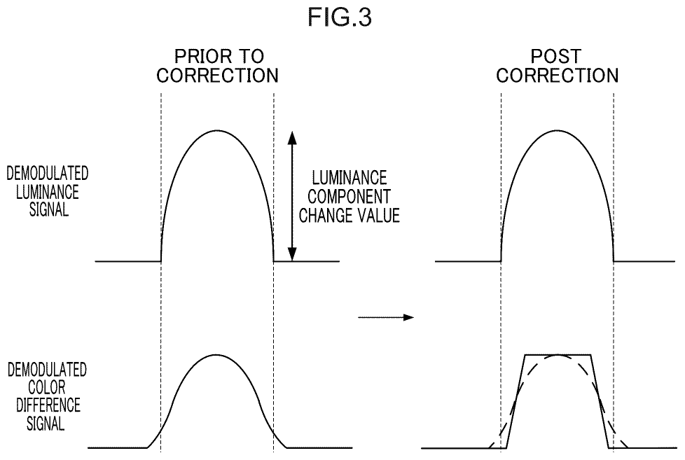

FIG. 3 illustrates an example of color difference components for a case in which a luminance component change value is a given threshold or greater. A demodulated luminance signal is illustrated at the top of the page in FIG. 3, and a demodulated color difference signal is illustrated at the bottom of the page in FIG. 3. As illustrated in FIG. 3, a frequency band range of the demodulated luminance signal is narrower than a frequency band range of the demodulated color difference signal. In cases in which, as illustrated in FIG. 3, the luminance component change value is a given threshold or greater, the correction section 150 multiplies the color difference components by a given positive number. The correction section 150 then adds the color difference components that have been multiplied by the given positive number to the demodulated color difference signal.

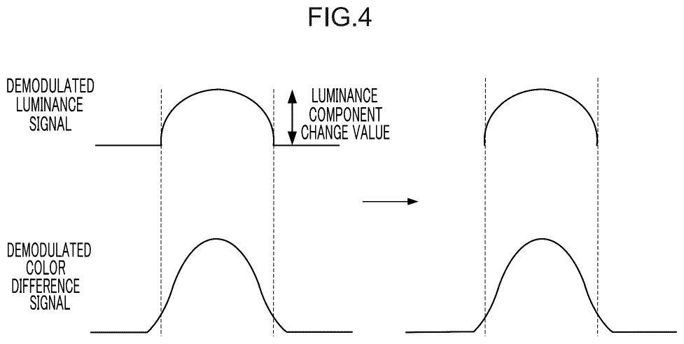

FIG. 4 illustrates an example of color difference components for a case in which a luminance component change value is less than a given threshold. A demodulated luminance signal is illustrated at the top of the page in FIG. 4, and a demodulated color difference signal is illustrated at the bottom of the page in FIG. 4. In cases in which, as illustrated in FIG. 4, the luminance component change value is less than a given threshold, the correction section 150 aborts correction of the color difference components.

The conversion section 160 converts YUV data, configured by combining the demodulated color difference signal including corrected color difference components with the demodulated luminance signal, by conversion into RGB data. Note that, even for demodulated color difference signals for which the correction of the color difference components was aborted, the conversion section 160 still converts the YUV data, configured by combining this demodulated color difference signal with the demodulated luminance signal, by conversion into RGB data. Specifically, the conversion section 160 acquires RGB data by inputting YUV data into a known equation. The conversion section 160 outputs the RGB data to the output section 170.

The output section 170 outputs the RGB data through the communication section 17 to a display device provided externally to the correction device 10. However, there is no limitation to such an example. For example, in cases in which the correction device 10 is provided with a display section, the RGB data may be output to the display section provided to the correction device 10.

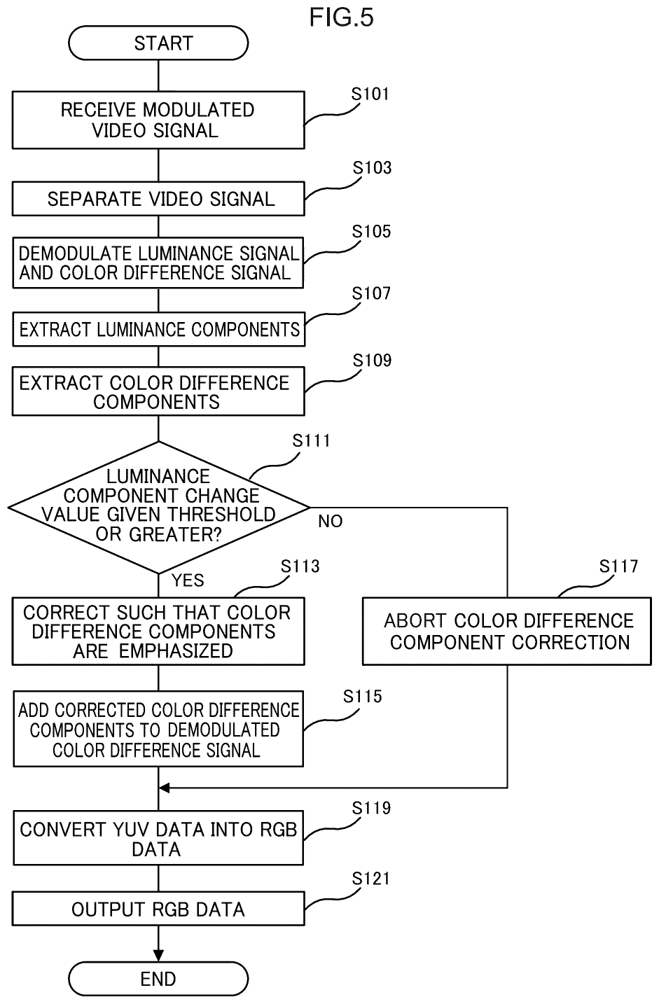

Next, description follows regarding a flow of correction processing in the correction device 10 according to the present exemplary embodiment, with reference to FIG. 5. The correction processing is an example of processing that the correction program 12A causes to be executed by the CPU 11, serving as a computer.

At step S101 of FIG. 5, the CPU 11 receives a modulated video signal.

At step S103, the CPU 11 separates the video signal into a luminance signal and a color difference signal.

At step S105, the CPU 11 demodulates the luminance signal and the color difference signal.

At step S107, the CPU 11 extracts luminance components from the demodulated luminance signal.

At step S109, the CPU 11 extracts color difference components from the demodulated color difference signal.

At step S111, the CPU 11 determines whether or not a luminance component change value is a given threshold or greater. The CPU 11 transitions to step S113 in cases in which the luminance component change value is the given threshold or greater (step S111: YES). However, the CPU 11 transitions to step S117 in cases in which the luminance component change value is less than the given threshold (step S111: NO).

At step S113, the CPU 11 corrects so as to emphasize the color difference components. Specifically, the CPU 11 multiplies the color difference components by a given positive number.

At step S115, the CPU 11 adds the corrected color difference components to the demodulated color difference signal.

At step S117, the CPU 11 abandons correction of the color difference components.

At step S119, the CPU 11 converts YUV data, configured by combining the demodulated color difference signal with the demodulated luminance signal, by conversion into RGB data.

At step S121, the CPU 11 outputs the RGB data. Specifically, the CPU 11 outputs the RGB data through the communication section 17 to the display device. The correction processing is then ended.

Note that the processing executed by the CPU reading software (a program) in the present exemplary embodiment may be executed by various processors other than a CPU. Examples of such processors include programmable logic devices (PLD) that allow circuit configuration to be modified post-manufacture, such as a field-programmable gate array (FPGA), and dedicated electric circuits, these being processors including a circuit configuration custom-designed to execute specific processing, such as an application specific integrated circuit (ASIC). The above processing may be executed by any one of these various types of processors, or may be executed by a combination of two or more of the same type or different types of processors (such as plural FPGAs, or a combination of a CPU and an FPGA). The hardware structure of these various types of processors is more specifically an electric circuit combining circuit elements such as semiconductor elements.

Moreover, although in the present exemplary embodiment a mode was described in which the program was pre-stored (installed) on the ROM, there is no limitation thereto. The program may be supplied in a format stored on a recording medium such as a compact disc read only memory (CD-ROM), digital versatile disc read only memory (DVD-ROM), universal serial bus (USB) memory, or the like. The program may also be in a format downloadable from an external device through the communication section 17.

The flow of processing described in the present exemplary embodiment is also merely an example thereof, and redundant steps may be omitted, new steps may be added, and the processing sequence may be swapped around within a range not departing from the spirit of the present disclosure.

In addition thereto, the configuration of the correction device 10 as described in the present exemplary embodiment is merely an example thereof, and may be modified according to circumstances within a range not departing from the spirit of the present disclosure.

What is claimed is:

1. A correction device comprising:
a memory; and
a processor coupled to the memory, the processor configured to:
receive a modulated video signal;
separate the modulated video signal into a color difference signal and a luminance signal; and
in cases in which a luminance component change value in a given frequency band in a demodulated luminance signal, demodulated from the luminance signal, is a given threshold or greater, perform correction such that color difference components present in a demodulated color difference signal demodulated from the color difference signal and corresponding to the luminance components are emphasized, compared to cases in which the change value is less than the given threshold.

2. The correction device of claim 1, wherein the processor is configured to abort the correction of the color difference components, in cases in which the luminance component change value is less than the given threshold.

3. The correction device of claim 1, wherein a frequency band range of the demodulated luminance signal is narrower than a frequency band range of the demodulated color difference signal.

4. The correction device of claim 1, wherein the processor is further configured to output RGB data converted from YUV data configured by combining the demodulated color difference signal including the corrected color difference components with the demodulated luminance signal.

5. A non-transitory computer-readable medium storing a correction program that is executable by a computer to perform processing comprising:
receiving a modulated video signal;
separating the modulated video signal into a color difference signal and a luminance signal; and
in cases in which a luminance component change value of a given frequency band in a demodulated luminance signal, demodulated from the luminance signal, is a given threshold or greater, performing correction such that color difference components present in a demodulated color difference signal demodulated from the color difference signal and corresponding to the luminance components are emphasized, compared to cases in which the change value is less than the given threshold.

6. The non-transitory computer-readable medium of claim 5, wherein the correction program causes the computer to perform process of aborting the correction of the color difference components, in cases in which the luminance component change value is less than the given threshold.

7. The non-transitory computer-readable medium of claim 5, wherein a frequency band range of the demodulated luminance signal is narrower than a frequency band range of the demodulated color difference signal.

8. The non-transitory computer-readable medium of claim 5, wherein the correction program causes the computer to perform process of outputting RGB data converted from YUV data configured by combining the demodulated color difference signal including the corrected color difference components with the demodulated luminance signal.

9. A correction method of processing executed by a computer, the processing comprising:
receiving a modulated video signal;
separating the modulated video signal into a color difference signal and a luminance signal; and
in cases in which a luminance component change value of a given frequency band in a demodulated luminance signal, demodulated from the luminance signal, is a given threshold or greater, performing correction such that color difference components present in a demodulated color difference signal demodulated from the color difference signal and corresponding to the luminance components are emphasized, compared to cases in which the change value is less than the given threshold.

10. The correction method of claim 9, wherein the computer further performs process of aborting the correction of the color difference components, in cases in which the luminance component change value is less than the given threshold.

11. The correction method of claim 9, wherein a frequency band range of the demodulated luminance signal is narrower than a frequency band range of the demodulated color difference signal.

12. The correction method of claim 9, wherein the computer further performs process of outputting RGB data converted from YUV data configured by combining the demodulated color difference signal including the corrected color difference components with the demodulated luminance signal.
